(19) United States
(12) Patent Application Publication
(10) Pub. No.: US 2022/0231534 A1
(43) Pub. Date: Jul. 21, 2022

(54) ENSURING AN EMERGENCY OPERATION OF AN ACTUATOR

(71) Applicant: Schaeffler Technologies AG & Co. KG, Herzogenaurach (DE)

(72) Inventors: Martin Zimmermann, Sasbach (DE); Daniel Horn, Achern (DE); Utku Karakas, Karlsruhe (DE)

(73) Assignee: Schaeffler Technologies AG & Co. KG, Herzogenaurach (DE)

(21) Appl. No.: 17/611,220

(22) PCT Filed: Apr. 16, 2020
(86) PCT No.: PCT/DE2020/100309

§ 371 Date: Nov. 15, 2021

(30) Foreign Application Priority Data
May 16, 2019 (DE) 10 2019 112 874.9

(51) Int. Cl. H02J 9/06; H02J 7/34; B60R 16/033

(52) U.S. Cl. CPC H02J 9/061; B60R 16/033; H02J 7/345

(57) ABSTRACT

A method for ensuring emergency operation of an actuator of a motor vehicle in the event of failure of an electrical supply line for a control unit of the actuator includes supplying at least one driver for the actuator with electrical voltage by a capacitor. The capacitor may be charged from an energy store of the motor vehicle or kept in a charged state during normal operation. A logic module of the control unit may undergo a reset in order to trigger the emergency operation.

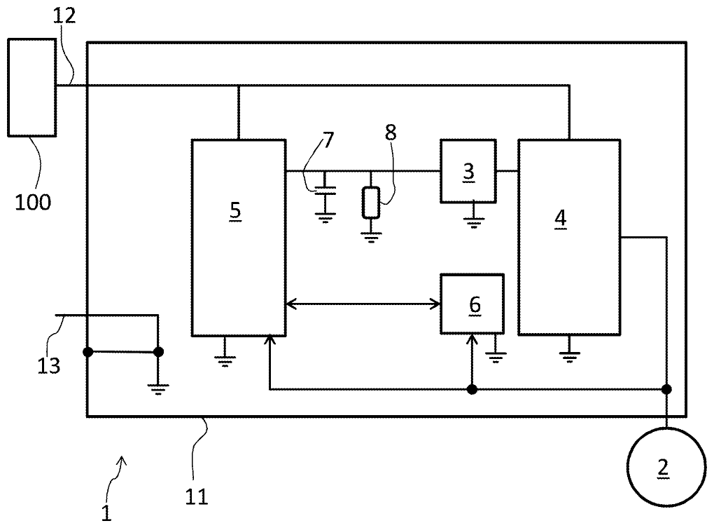

### CROSS-REFERENCE TO RELATED APPLICATIONS

This application is the United States National Phase of PCT Appln. No. PCT/DE2020/100309 filed Apr. 16, 2020, which claims priority to German Application No. DE102019112874.9 filed May 16, 2019, the entire disclosures of which are incorporated by reference herein.

### TECHNICAL FIELD

The present disclosure relates to a method for ensuring an emergency operation of an actuator of a motor vehicle and a corresponding control unit for the actuator.

### BACKGROUND

Actuators are used in modern motor vehicles, e.g., for actuating elements of the drive train, such as clutches or brakes. These actuators are controlled by control units which must be supplied with electrical energy, which is commonly carried out by the battery of the motor vehicle. If the control unit is not supplied with electrical energy, the actuator can no longer fulfill its function. Since this can lead to dangerous driving conditions of the motor vehicle, emergency operation of the actuator must be reliably ensured if the regular power supply of the control unit fails.

From German patent DE 10 2014 215 263 A1, it is known to supply the control unit of an actuator with power via an alternative power line in the event of failure of the regular power supply of the control unit to ensure emergency operation. A line is used as an alternative power line which is primarily intended for another purpose in the motor vehicle. The option of also being able to use such a power line to supply the control unit of the actuator is achieved by means of suitable interconnection. However, the disadvantage here is that at least the current conduction on the alternative line must be guaranteed.

### SUMMARY

The present disclosure specifies a method for ensuring emergency operation of an actuator which, unlike the prior art, does not depend on the function of an alternative power line. A corresponding control unit for an actuator should also be specified.

The method according to the disclosure is provided to ensure emergency operation of an actuator of a motor vehicle in the event of failure of an electrical supply line for a control unit of the actuator. The method according to the disclosure includes at least one driver for the actuator that is supplied with electrical voltage by a capacitor. In this way, the emergency operation of the actuator is not dependent on an alternative line to supply power to the control unit.

As long as the motor vehicle is in normal operation, in one embodiment, the capacitor can be charged from an energy store, for example a battery, of the motor vehicle, or can be kept in a charged state.

In one embodiment, a logic module of the control unit undergoes a reset in order to trigger the emergency operation. The logic module can be, for example, a microprocessor or microcontroller. In a special further development, at least one output of the logic module becomes high-resistance.

In one configuration of the above embodiments, at least one resistor at an input of the driver for the actuator is supplied with current via the capacitor to trigger the emergency operation. For example, the resistor can ensure that a voltage is present at the input of the driver, said voltage inducing an output stage for the actuator to effect a behavior, which corresponds to the emergency operation. The behavior which corresponds to the emergency operation can include bringing a motor of the actuator to a controlled standstill.

The control unit according to the disclosure for an actuator of a motor vehicle includes at least one logic module and a driver for the actuator. According to the disclosure, a capacitor is provided to supply at least the driver with electrical voltage in the event of emergency operation.

In one embodiment, a resistor is provided at least at one input of the driver. The capacitor is also provided to supply the resistor with power in emergency operation. For example, the resistor can be dimensioned in such a way that, in emergency operation, a voltage is present at the input of the driver, said voltage inducing an output stage for the actuator to effect a behavior, which corresponds to the emergency operation. The behavior which corresponds to the emergency operation can include bringing a motor of the actuator to a controlled standstill.

In one embodiment, the control unit includes a monitoring circuit which is provided to trigger a reset of the logic module for initiating the emergency operation.

The logic module can be connected to a vehicle ground via a housing of the control unit.

### BRIEF DESCRIPTION OF THE DRAWINGS

The present disclosure is explained in more detail below with reference to the accompanying drawing. The single FIGURE shows a schematic circuit diagram of an embodiment of a control unit according to the disclosure.

### DETAILED DESCRIPTION

The drawing is only a schematic exemplary embodiment and does not restrict the disclosure to the exemplary embodiment shown. Furthermore, the person skilled in the art is familiar with a plurality of specific configurations of individual elements that are only shown schematically, such as logic module and driver, together with special wiring requirements that depend on the specific configuration. The main purpose of the drawing is to clarify the interrelationship between the individual elements.

The single FIGURE shows a control unit 1 for an actuator 2. The control unit 1 has a housing 11 and is supplied with electrical energy from an energy store 100 via a supply line 12 and a ground line 13. In the example shown, the housing 11 is grounded. A microprocessor 5 forms a logic module of the control unit 1, and a driver 3 and an output stage 4 are provided to control the actuator 2. If the voltage supply via the supply line 12 fails, the actuator 2 could no longer be reliably controlled; for example, it would no longer be possible to stop a motor of the actuator 2 quickly and in a controlled manner. To avoid this, a capacitor 7 is provided according to the disclosure.

In normal operation, the capacitor 7 is charged or kept in the charged state via the supply line 12 and the microprocessor 5. If the voltage supply by supply line 12 is lost, the capacitor 7 can supply the driver 3 with voltage. For this purpose, the capacitor 7 is approximately dimensioned in such a way that the voltage supply of the driver 3 can be maintained for a sufficiently long time to stop the motor of the actuator 2. In order to ensure the correct input voltage at the driver 3, a resistor 8 (pull-up/pull-down resistor) is also provided. The correct input voltage is one which ultimately leads to the desired behavior of the output stage 4, so that, for example, the motor of the actuator 2 is slowed down.

The loss of the voltage supply via supply line 12 can be detected in various ways, for example, but not limited to, via a resistor in supply line 12 and a comparator bridging this resistor. Such sensors were not shown; however, the output of such sensors is supplied to a monitoring circuit 6. If the failure of the voltage supply is determined, the monitoring circuit 6 triggers a reset of the microprocessor 5, as a result of which its outputs become high-resistance. This ensures the voltage supply of the driver 3 by the capacitor 7 for a sufficiently long time.

### REFERENCE NUMERALS

1 Control unit
2 Actuator
3 Driver
4 Output stage
5 Microprocessor (logic module)
6 Monitoring circuit
7 Capacitor
8 Resistor
11 Housing
12 Supply line
13 Ground line
100 Energy store

1.-10. (canceled)

11. A method for ensuring emergency operation of an actuator of a motor vehicle in the event of failure of an electrical supply line for a control unit of the actuator, comprising:
supplying at least one driver for the actuator with electrical voltage by a capacitor.

12. The method of claim 11, wherein the capacitor is charged from an energy store of the motor vehicle or kept in a charged state during normal operation.

13. The method of claim 11, wherein a logic module of the control unit undergoes a reset in order to trigger the emergency operation.

14. The method of claim 13, wherein at least one output of the logic module becomes high-resistance as a result of the reset.

15. The method of claim 11, wherein at least one resistor to an input of the driver is supplied with current via the capacitor to trigger the emergency operation.

16. The method of claim 15, wherein a voltage is applied through the resistor at the input of the driver to induce an output stage for the actuator to effect a behavior corresponding to the emergency operation of the actuator.

17. A control unit for an actuator of a motor vehicle, comprising:
a logic module;
a driver for the actuator; and
a capacitor to supply at least the driver with electrical voltage in the event of emergency operation.

18. The control unit of claim 17, further comprising a resistor at least at one input of the driver, wherein the capacitor is provided to supply the resistor with power in emergency operation.

19. The control unit of claim 18, wherein the resistor is dimensioned such that a voltage is applied at the input of the driver in emergency operation that induces a behavior corresponding to the emergency operation in an output stage for the actuator.

20. The control unit of claim 17, wherein the control unit comprises a monitoring circuit provided to trigger a reset of the logic module for initiating the emergency operation.
